(19) United States
(12) Patent Application Publication
(10) Pub. No.: US 2022/0386623 A1
(43) Pub. Date: Dec. 8, 2022

(54) Compositions and Methods for Promoting Plant Health

(71) Applicant: Locus Agriculture IP Company, LLC, Solon, OH (US)

(72) Inventors: Paul ZORNER, Encinitas, CA (US); Sean FARMER, Ft. Lauderdale, FL (US); Ken ALIBEK, Solon, OH (US)

(21) Appl. No.: 17/771,643

(22) PCT Filed: Jun. 15, 2021
(86) PCT No.: PCT/US2021/037316

§ 371 Date: Apr. 25, 2022

Related U.S. Application Data
(60) Provisional application No. 63/039,184, filed on Jun. 15, 2020.

(51) Int. Cl. A01N 63/22; A01N 63/38; A01P 21/00

(52) U.S. Cl. CPC A01N 63/22; A01N 63/38; A01P 21/00

(57) ABSTRACT

Compositions and methods are provided for controlling infections in plants. In particular, the subject invention relates to treatments for bacterial or fungal infections affecting plant vascular systems using microbes and/or their growth by-products, such as biosurfactants.

### CROSS-REFERENCE TO RELATED APPLICATION

This application claims priority to U.S. Provisional Patent Application No. 63/039,184, filed Jun. 15, 2020, which is incorporated herein by reference in its entirety.

### BACKGROUND OF THE INVENTION

A plant's vascular system comprises bundles of tissues, supported by fibrous material, which conduct water, minerals and other nutrients throughout the plant. Specifically, xylem tissue transports water and dissolved minerals that are absorbed through the roots and transported to the leaves, while phloem tissue transports nutrients produced via photosynthesis from the leaves to all other parts of the plant.

Vascular tissue is essential to the growth and survival of plants; however, certain pests and pathogens can infect the vascular tissue, or cause symptoms affecting the vascular tissue, which can cause often-fatal diseases and conditions in a plant or crop. Plant vascular infections can be caused by a variety of bacteria, fungi, viruses and in some cases, nematodes.

Bacterial invasion of the vascular system, for example, can cause blockage and prevent movement of water and nutrients through the vascular tissue. The resulting symptoms include drooping, wilting or even death of the above-ground structures of the plant. Bacterial pathogens can enter plants through wounds, insect bites, and/or through natural opening such as stomata and lenticels.

One bacterial pathogen of interest is Xylella fastidiosa. This bacterium is a slow growing, Gram-negative, rod-shaped aerobic bacterium, which is transmitted to plants via sap-feeding insect vectors. The vectors, mainly sharpshooter leafhoppers and spittlebugs, feed on xylem fluid, and in doing so, deposit the pathogenic bacteria into the xylem tissue.

Over time, Xylella forms a biofilm, or biofilm-like, layer within the xylem tissue and tracheary elements (xylem cells specialized for transporting water and solutes), blocking water transport and causing water stress and nutrient deficiencies. Symptoms of a Xylella infection include, for example, leaf necrosis and scorching, desiccation of berries and fruit, defoliation, and overall plant health decline.

There are at least five different subspecies of X. fastidiosa: fastidiosa, multiplex, pauca, sandyi, and tashke; and a potential sixth subspecies, morus. The plant host range of X. fastidiosa includes over 300 species, with pathogenicity in over 100 plant species including, for example, olive, grapevines, citrus, peach, coffee, almond, blueberry, elm, oleander, sycamore, sorghum, tobacco, lucerne, plum, oak, plane, mulberry, maple, and many herbaceous plant species. Not all infected plants exhibit symptoms, but even asymptomatic plants can spread disease.

Xylella fastidiosa is found predominantly in North and Central America; however, in 2013, Xylella subsp. pauca was detected in Apulia in Southern Italy, where it began infecting established olive trees. Satellite and weather imaging have provided estimates that roughly 6.5 million olive trees in the area were severely damaged by 2017 due to the infection, which causes olive quick decline syndrome (OQDS). Currently, thousands of acres of olive trees are being destroyed to try to stop the spread of the disease, with no treatment in sight.

In addition to biofilm formation in the xylem preventing proper hydraulic conductivity, leaf scorching and necrosis are caused by what is believed to be an overactive immune response to the infection that causes OQDS. RNA sequencing analysis has shown activation of major immunity pathways, including calcium transmembrane transporters and various enzymes that are responsible for the production of reactive oxygen species (ROS). It is predicted that the upregulation of genes that are responsible for hypersensitive reactions and plant death is a result of this increased immune response.

In citrus production, widespread infection of citrus plants by pathogens such as those that cause citrus greening disease and citrus canker disease has led to significant hardships for citrus growers. As much as entire crops have been lost to these bacterial infections, leading to a decline in the production, and an increase in price, of citrus products worldwide.

Citrus greening disease, which is also known as Huanglongbing (HLB) or yellow dragon disease, is a currently-incurable infection caused by Gram-negative Candidatus liberibacter spp. bacteria, namely Candidatus liberibacter asiaticus, Candidatus liberibacter africanus and Candidatus liberibacter americanus. All Ca. liberibacter spp. belong to the family Rhizobiacea and are transmitted by at least two species of citrus psyllids, Diaphorina citri Kuwayana (Asian citrus psyllid) and Trioza erytreae (del Guercio) (African citrus psyllid).

HLB has devastated millions of acres of citrus crops throughout the United States and other parts of the world. Infected trees produce fruits that are green, misshapen and bitter, which are unsuitable for sale. When a leaf is penetrated and the bacteria are transferred from the vector into the leaf, the bacteria initially travel quickly to the roots, where they replicate and damage the root system. The pathogen then travels throughout the plant, residing mainly intracellularly and causing distinct yet interrelated symptoms, such as starch accumulation in the sieve elements, plugged sieve pores, hypertrophic phloem parenchyma cells, structural changes of phloem tissue, phloem plugging with abundant callose depositions, phloem cell wall distortion and thickening, and eventually phloem collapse and necrosis. These changes can cause a cascade of further symptoms affecting, for example, photosynthesis, respiration and energy availability.

In general, most of the serious symptoms of HLB infection are a result of phloem disruption, compared with Xylella fastidiosa, which causes xylem disruption. Thus, HLB-infected tree death occurs less quickly than trees infected with Xylella fastidiosa.

Similarly to bacterial pathogens, fungal pests can also cause vascular-related plant diseases. Fungal infections are often spread by spores, which can be carried and disseminated by wind, water, dust, insects and birds. Vegetative fungal cells that exist in dead plant material also can be transmitted when they come in contact with a susceptible host. Fungal spores, however, are more resilient to environmental stressors, and thus can persist in media such as soil for extended periods of time in a dormant state.

Fusarium is a soil pathogen that is propagated by asexual spores. It infests the root system of plants and is drawn up into a plant through its vascular system. The fungus develops further colonies within the xylem, thus blocking the internal flow of nutrients and water. Banana plants and some palms are particularly susceptible to “Fusarium wilt,” which is caused by Fusarium oxysporumf sp. cubense, This strain is immune to all known fungicides.

When plants are infected by a pest or pathogen, their cells implement various defensive mechanisms against the invading entity. Plants do not have immune cells, per se, but have evolved what can be characterized as an innate immune system, where most or all of their cells exhibit immune capabilities.

Two types of immune pathways can be triggered in plants in response to infection or attack. The first pathway involves pattern recognition receptors (PRR), which are proteins on plant cell surfaces that recognize different molecules associated with invaders. These invader molecules are known as pathogen-associated molecular patterns (PAMPs), and can be attached to the surface of a pathogen and/or released by the pathogen upon infection. (Keener 2016).

Pathogen structures are detected by the PRR extracellular domain, with subsequent signal transduction in the cytoplasm. PAMP recognition leads to one or more defensive signals, including, for example, an oxidative burst by the generation of reactive oxygen species (ROS), calcium influx, activation of the mitogen-activated protein kinase (MAPK) cascade, nitric oxide (NO) burst, ethylene production, callose deposition at the cell wall, and expression of defense-related genes involved in immunity responses. (Dalio et al. 2017).

Some pathogens have evolved methods of overcoming the PAMP-triggered immunity using “effector” molecules, which interfere with the plant's initial defensive mechanisms. Xylella fastidiosa, for example, contains a long chain O-antigen that allows it to delay plant recognition, thus allowing it to bypass the innate immunity and become established in the plant host. In response, however, many plants also evolved a second immunity pathway—effector-triggered immunity (ETI). Similarly to PRR of PAMPs, plants can recognize effector molecules and initiate secondary immune cascades that boost the PAMP-triggered responses. In some instances, the plant undergoes a hypersensitive response, where localized plant cell death occurs to limit the spread of infection. (Keener 2016).

There are also instances where a plant's immune response can be improved prior to a serious pathogenic infection. Somewhat analogously to how a vaccine works, the plant's immune system can be “primed” or “pre-conditioned” by pre-exposure to priming agents, or molecules that are associated with a stressor or invader. Priming can occur as a result of, for example, interactions between a plant and a pathogen, a beneficial microorganism (e.g., rhizobacteria, mycorrhizal fungi), or by a natural or synthetic agricultural chemical. The plant is then placed into an induced state of defense and/or enhanced resistance, thus priming it for resisting and/or defending against a future attack. Following such responses, plants are cellularly and organismally reprogrammed to “remember” the exposure at a molecular level, thus responding with more intensity, speed and/or sensitivity compared with non-primed plants in response to the same stress conditions. (Tugizimana et al. 2018).

Currently, there are few effective methods for growers to control plant vascular infections caused by bacteria or fungi. Antibiotics can be useful, although the rise in antibiotic-resistant bacterial strains, and the danger of resistant strains evolving, make antibiotics a less effective, and less desirable, option. For vector-borne diseases, insecticidal treatments can be used to control the vectors rather than the pathogen itself. Bactericidal and fungicidal chemicals can also be used, but many of these chemicals can persist in soil and ground water, and can cause harm to consumers and the environment. Typically, a grower is left with no other option but to sequester an infected plant, or in dire circumstances, burn or otherwise destroy an entire crop if an infection becomes too widespread. This is particularly true of vascular pests that are soil-borne, such as Xylella and Fusarium.

There is a continuing need for improved, non-toxic and environmentally-friendly methods of enhancing and protecting crop production at a low cost. In particular, given the potentially dire consequences of plant vascular infections, and the lack of effective methods for treating and/or preventing them, new compositions and/or methods for promoting the health of plants and crops at risk of such infections are needed.

### BRIEF SUMMARY OF THE INVENTION

The subject invention provides compositions comprising microorganisms and/or their growth by-products, as well as methods of using them for promoting the health of plants infected, or at risk for infection, with a vascular infection. Advantageously, in preferred embodiments, the compositions and methods are effective while being environmentally-friendly and non-toxic.

In preferred embodiments, the subject invention provides plant health-promoting compositions comprising one or more non-pathogenic microorganisms and/or growth by-products thereof. Also provided are methods of producing the microorganism and/or growth by-products of the plant health-promoting compositions, as well as methods of using them for promoting plant health.

In certain embodiments, the one or more microorganisms are selected from, for example, nitrogen fixers (e.g., Azotobacter vinelandii), potassium mobilizers (e.g., Frateuria aurantia), and others including, for example, mycorrhizal fungi, Trichoderma harzianum, Myxococcus xanthus, Pseudomonas chlororaphis, Bacillus amyloliquefaciens (e.g., strain NRRL B-67928 “B. amy”), Bacillus licheninformis, Bacillus subtilis (e.g., strain NRRL B-68031 “B4”), Wickerhamomyces anomalus (e.g., strain NRRL Y-68030), Starmerella bombicola, Saccharomyces boulardii, Debaryomyces hensenii, Pichia occidentalis, Pichia kudriavzevii, and/or Meyerozyma guilliermondii.

In certain embodiments, the compositions of the subject invention comprise a Trichoderma spp. fungus and a Bacillus spp. bacterium, although other combinations are envisioned.

In a specific exemplary embodiment, the composition comprises Trichoderma harzianum and Bacillus amyloliquefaciens. In one embodiment, the B. amyloliquefaciens is strain NRRL B-67928, or “B. amy.”

In one embodiment, the composition can comprise from 1 to 99% Trichoderma by volume and from 99 to 1% Bacillus by volume. In preferred embodiments, the cell count ratio of Trichoderma to Bacillus is about 1:4.

The species and ratio of types of microorganisms, as well as the choice of additives in the composition, can be determined according to, for example, the plant being treated, the soil type where the plant is growing, the health of the plant at the time of treatment, the specific pathogen(s) infecting the plant, as well as other factors. Thus, the composition can be customizable for any given crop.

The microorganisms of the subject compositions can be obtained through cultivation processes ranging from small to large scale. These cultivation processes include, but are not limited to, submerged cultivation/fermentation, solid state fermentation (SSF), and modifications, hybrids and/or combinations thereof.

In certain embodiments, the plant-health promoting composition can comprise substrate leftover from cultivation, and/or purified or unpurified growth by-products, such as biosurfactants, killer toxins, enzymes, polyketides, and/or other metabolites. The microbes can be live or inactive, although, in preferred embodiments, the microbes are live.

The composition is preferably formulated for application to soil, seeds, whole plants and/or plant parts (including, but not limited to, roots, tubers, stems, flowers, leaves and/or the vascular system). In certain embodiments, the composition is formulated as a soil amendment. In certain other embodiments, the composition is formulated as an injectable composition.

In one embodiment, the composition can further comprise a source of protein and/or other nutrients, such as, for example, carbon, nitrogen, vitamins, micronutrients and amino acids, for enhanced growth of the beneficial microorganisms and production of health-promoting growth by-products.

The composition can be used either alone or in combination with other compounds for efficiently promoting plant health. For example, in some embodiments, the composition can comprise additional components, such as commercial and/or homemade herbicides, fertilizers, pesticides, repellants and/or soil amendments that are compatible with the one or more microorganisms and/or microbial growth by-products of the composition.

In one embodiment, the composition can further comprise, and/or be used alongside, a biosurfactant composition.

In preferred embodiments, methods are provided for promoting the health of a plant that is infected by a pest or pathogen. In certain embodiments, the method can comprise contacting a health-promoting composition of the subject invention with the plant and/or its surrounding environment.

In some embodiments, the method promotes plant health by directly controlling a pest or pathogen, or a vector that carries a pest or pathogen, and/or by treating a symptom caused by infection with a pest or pathogen. In certain embodiments, the pest or pathogen causes a disease and/or symptom affecting the plant vascular tissue, such as, e.g., Xylella fastidiosa, Candidatus liberibacter spp., Xanthomonas spp., Ralstonia solanacearum, Erwinia tracheiphila, Curtobacterium flaccumfaciens, Pantoea stewartii, Verticillium spp., Fusarium spp., Ceratocystis spp., Ophiostoma ulmi, Bretziella fagacearum, Phytoplasma palmae and Acromonium diospyri.

In a specific embodiment, the pest or pathogen is a biofilm-forming bacterium, such as Xylella fastidiosa, which forms biofilms in the vascular tissue (e.g., xylem and/or phloem tissue), thereby choking off the supply of water and/or nutrients throughout the plant.

In some embodiments, the method promotes plant health by promoting the plant's immune response to a pest or pathogen, thereby enhancing the plant's ability to survive and/or resist an infection by the pest or pathogen.

In some embodiments, the method promotes plant health by expanding the plant's root system to decrease pressure on, and increase the functionality of, the diseased roots themselves.

In some embodiments, the method promotes plant health by improving water and nutrient transport through the xylem and phloem, in diseased plants and/or plants at risk for disease.

In some embodiments, the method promotes plant health by improving nutrient availability to the root system.

In some embodiments, the pest or pathogen that infects the plant induces a response in the plant that is analogous to an auto-immune response in animals, where the plant initiates an immune response such as, for example, over-production of polysaccharides that can plug the phloem and/or altering of the structure of phloem cell walls to prevent the further spread of pathogenic cells. By reducing the nutrient and water stress on the plant's roots and vascular system, the subject methods can, in some embodiments, reduce the “auto-immune” stress that is induced by the presence of the pest or pathogen, thereby alleviating the symptoms it causes.

In certain embodiments, the composition is contacted with a plant part. In a specific embodiment, the composition is contacted with one or more roots of the plant. The composition can be applied directly to the roots, e.g., by spraying or pouring onto the roots, and/or indirectly, e.g., by administering the composition to the soil in which the plant roots are growing (i.e., the rhizosphere). The composition can be applied to the seeds of the plant prior to, or at the time of, planting, or to any other part of the plant and/or its surrounding environment.

In certain embodiments, the method can further comprise applying the health-promoting composition with a biosurfactant composition.

Biosurfactants that can be used according to the subject invention include, for example, glycolipids, cellobiose lipids, lipopeptides, flavolipids, phospholipids, and high-molecular-weight polymers such as lipoproteins, lipopolysaccharide-protein complexes, and/or polysaccharide-protein-fatty acid complexes.

In one embodiment, the biosurfactants comprise glycolipids such as, for example, rhamnolipids (RLP), sophorolipids (SLP), trehalose lipids or mannosylerythritol lipids (MEL). In one embodiment, the biosurfactants comprise lipopeptides, such as, e.g., surfactin, iturin, fengycin, athrofactin, viscosin and/or lichenysin.

Advantageously, biosurfactants can provide health-promoting benefits including, for example, enhancing the water solubility and/or absorption of nutrients from soil, and/or reducing the surface tension of water around the roots and within the vascular system to help with nutrient and water transport. Furthermore, due to the amphiphilic nature of biosurfactant molecules, they are capable of traveling through the plant's vascular system, where they can promote immune health by, for example, dissolving the polysaccharide matrix that helps form xylem- and phloem-clogging biofilms.

In one embodiment, the method comprises applying the biosurfactant treatment composition to a plant and/or its surrounding environment either after, or simultaneously with, application of the health-promoting composition.

In some embodiments, the biosurfactant composition is applied to the soil in which the plant is growing, where it can be absorbed by plant roots and transported through the vascular system of the plant.

In some embodiments, the biosurfactant composition is applied directly to a part of the plant that is experiencing vascular system symptoms, for example, above-ground plant parts. Such direct application can comprise, for example, using a syringe to inject the biosurfactant treatment into, for example, the plant's trunk, branches, and/or stems. Direct application can also comprise, for example, spraying the composition onto the trunk, branches, stems, foliage, flowers and/or fruits of the plant.

In some embodiments, methods for improving plant health are provided wherein the biosurfactant composition is applied to the plant (e.g., via injection) and/or its environment without applying the microbe-based health-promoting composition to the soil. In some embodiments, the health-promoting composition is applied to the soil without application of a biosurfactant composition to the plant and/or its environment.

Advantageously, the subject method can be used to enhance health, growth and/or yields in plants having compromised immune health due to an infection by pests or pathogens, particularly those that affect the plant vascular system. Furthermore, the subject method can be used to reduce the amount of plant and/or crop loss due to plant damage and/or death caused by such infections.

### BRIEF DESCRIPTION OF THE FIGURES

FIGS. 1A-1B show increases in (A) root mass (g) for white grapefruit and (B) dry root mass (g/sample) for orange trees in Florida treated with a composition comprising T. harzianum and B. amy according to embodiments of the subject invention.

FIG. 2 shows increase in chlorophyll rating for tobacco plants treated with a composition comprising T. harzianum and B. amy according to embodiments of the subject invention.

### DETAILED DESCRIPTION OF THE INVENTION

The subject invention provides compositions comprising microorganisms and/or their growth by-products, as well as methods of using them for promoting the health of plants infected with vascular infections. Advantageously, in preferred embodiments, the compositions and methods are effective while being environmentally-friendly and non-toxic.

In preferred embodiments, the subject invention provides plant health-promoting compositions comprising one or more non-pathogenic microorganisms and/or growth by-products thereof.

In preferred embodiments, methods are also provided for promoting the health of a plant that is infected by a pest or pathogen that affects the plant's vascular system. In certain embodiments, the method can comprise contacting a health-promoting composition of the subject invention with the plant and/or its surrounding environment. In certain embodiments, the method can comprise contacting a biosurfactant composition with the plant and/or its surrounding environment. In some embodiments, both the microbe-based health-promoting composition and the biosurfactant composition are applied to the plant and/or its surrounding environment.

### Selected Definitions

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture are the care, monitoring and maintenance of soil.

As used herein, a “biofilm” is a complex aggregate of microorganisms, wherein the cells adhere to each other using, for example, an exopolysaccharide matrix. In some embodiments, biofilms can adhere to surfaces. The cells in biofilms are phenotypically distinct from planktonic cells of the same organism, which are single cells that can float or swim in liquid medium.

As used herein, “environmental stressor” refers to an abiotic, or non-living, condition that has a negative impact on a living organism in a specific environment. The environmental stressor must influence the environment beyond its normal range of variation to adversely affect the population performance or individual physiology of the organism in a significant way. Examples of environmental stressors include, but are not limited to, drought, extreme temperatures, flood, high winds, natural disasters, soil pH changes, high radiation, compaction of soil, pollution, and others.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of, for example, the genes or sequences that flank it in its naturally-occurring state. A purified or isolated polypeptide is, for example, free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. Examples of metabolites include, but are not limited to, biosurfactants, biopolymers, enzymes, acids, polyketides, solvents, alcohols, proteins, vitamins, minerals, microelements, and amino acids.

As used herein, “modulate” means to cause an alteration (e.g., increase or decrease).

As used herein, a “pest” is any organism, other than a human, that is destructive, deleterious and/or detrimental to humans or human concerns (e.g., agriculture, horticulture). In some, but not all instances, a pest may be a “pathogen,” meaning capable of causing disease. Pests may cause or be a vector for infections, infestations and/or disease, or they may simply feed on or cause other physical harm to living tissue. Pests may be single- or multi-cellular organisms, including but not limited to, viruses, fungi, bacteria, protozoa, arthropods, mammals, birds, parasites, and/or nematodes. In certain embodiments, weeds or other invasive plants that compete for resources with a plant of interest are also considered pests.

As used herein, the term “control” used in reference to a pest means killing, disabling, immobilizing, or reducing population numbers of a pest, or otherwise rendering the pest substantially incapable of reproducing and/or causing harm (e.g., symptoms).

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning the situation or occurrence may still develop at a later time. In some embodiments, prevention can include reducing the severity of the onset of a disease, condition or disorder, and/or inhibiting the progression of the condition or disorder to a more severe condition or disorder.

As used herein, “promoting” means improving, enhancing or increasing. For example, promoting plant health means improving the plant's ability to grow and thrive (which includes increased seed germination, seedling emergence, and/or vigor); improved ability to withstand transplant shock; improved ability to ward off and/or survive pests and/or diseases; improved ability to compete with weeds; and improved ability to survive environmental stressors, such as droughts and/or overwatering.

Promoting plant growth and/or plant biomass means increasing the size and/or mass of a plant above and/or below the ground (e.g., increased canopy/foliar volume, bud size, height, trunk caliper, branch length, shoot length, stalk length, protein content, root size/density and/or overall growth index), and/or improving the ability of the plant to reach a desired size and/or mass.

Promoting yields mean improving the end products produced by the plants in a crop, for example, by increasing the number, amount and/or size of fruits, leaves, roots, flowers, buds, stalks, seeds, fibers, extracts and/or tubers per plant, and/or improving the quality thereof.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduce” refers to a negative alteration, and the term “increase” refers to a positive alteration, each of at least 1%, 5%, 10%, 25%, 50%, 75%, or 100%.

As used herein, “reference” refers to a standard or control condition.

As used herein, a “soil amendment” or a “soil conditioner” is any compound, material, or combination of compounds or materials that are added into soil to enhance the physical properties of the soil. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the growth and health of plants by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

As used herein, “surfactant” refers to a compound that lowers the surface tension (or interfacial tension) between two liquids or between a liquid and a solid. Surfactants act as, e.g., detergents, wetting agents, emulsifiers, foaming agents, and dispersants. A “biosurfactant” is a surfactant produced by a living organism and/or produced from naturally-derived materials.

As used herein, “treatment” means the eradicating, reducing, ameliorating, reversing, or preventing of a degree, sign or symptom of a condition or disorder to any extent, and includes, but does not require, a complete cure of the condition or disorder. Treating can be curing, improving, or partially ameliorating a disorder. In some embodiments, treatment can comprise controlling a pest that causes an infection, infestation, or disease.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Plant Health-Promoting Compositions

In preferred embodiments, a microbe-based plant health-promoting composition is provided, comprising one or more non-pathogenic microorganisms and/or growth by-products thereof. The species and ratio of microorganisms and other additional ingredients in the composition can be customized according to, for example, the plant being treated, the soil type where the plant is growing, the health of the plant at the time of treatment, pests or pathogens affecting the plant, as well as other factors.

In certain embodiments, the plant health-promoting composition is a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, biosurfactants, toxins, enzymes, polyketides, and/or other cellular components. The microbes may be intact or lysed. In some embodiments, the microbes are present, with medium in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹² or 1×10¹³, or more, CFU per milliliter of the composition.

The microorganisms of the subject compositions can be obtained through cultivation processes ranging from small to large scale. These cultivation processes include, but are not limited to, submerged cultivation/fermentation, solid state fermentation (SSF), and combinations thereof.

The composition may be, for example, at least, by weight, 1%, 5%, 10%, 25%, 50%, 75%, or 100% growth medium. The amount of biomass in the composition, by weight, may be, for example, anywhere from 0% to 100%, 10% to 75%, or 25% to 50%, inclusive of all percentages therebetween.

In one embodiment, the microorganisms of the subject composition comprise about 5 to 20% of the total composition by weight, or about 8 to 15%, or about 10 to 12%.

In some embodiments, the one or more microbes are present at a concentration of 1×10³ to 1×10¹², 1×10⁴ to 1×10¹¹, 1×10⁵ to 1×10¹⁰, or 1×10⁶ to 1×10⁹ CFU/ml each.

The product of fermentation may be used directly, with or without extraction or purification. If desired, extraction and purification can be easily achieved using standard extraction and/or purification methods or techniques described in the literature.

The microorganisms in the plant health-promoting composition may be in an active or inactive form, or in the form of vegetative cells, spores and/or any other form of propagule.

The microorganisms useful according to the subject invention can be, for example, non-plant-pathogenic strains of bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In some embodiments, the composition can further comprise one or more other microbes, including bacteria, yeasts and/or fungi, such as mycorrhizal fungi.

As used herein, “mycorrhizal fungi” includes any species of fungus that forms a non-parasitic mycorrhizal relationship with a plant's roots. The fungi can be ectomycorrhizal fungi and/or endomycorrhizal fungi, including subtypes thereof (e.g., arbuscular, ericoid, and orchid mycorrhizae).

Non-limiting examples of mycorrhizal fungi according to the subject invention include species belong to Glomeromycota, Basidiomycota, Ascomycota, Zygomycota, Helotiales, and Hymenochaetales, as well as Acaulospora spp. (e.g., A. alpina, A. brasiliensis, A. foveata), Amanita spp. (e.g., A. muscaria, A. phalloides), Amphinema spp. (e.g., A. byssoides, A. diadema, A. rugosum), Astraeus spp. (e.g., A. hygrometricum), Byssocorticium spp. (e.g., B. atrovirens), Byssoporia terrestris (e.g., B. terrestris sartoryi, B. terrestris lilacinorosea, B. terrestris aurantiaca, B. terrestris sublutea, B. terrestris parksii), Cairneyella spp. (e.g., C. variabilis), Cantherellus spp. (e.g., C. cibarius, C. minor, C. cinnabarinus, C. friesii), Cenococcum spp. (e.g., C. geophilum), Ceratobasidium spp. (e.g., C. cornigerum), Cortinarius spp. (e.g., C. austrovenetus, C. caperatus, C. violaceus), Endogone spp. (e.g., E. pisiformis), Entrophospora spp. (e.g., E. colombiana), Funneliformis spp. (e.g., F. mosseae), Gamarada spp. (e.g., G. debralockiae), Gigaspora spp. (e.g., G. gigantean, G. margarita), Glomus spp. (e.g., G. aggregatum, G. brasilianum, G. clarum, G. deserticola, G. etunicatum, G. fasciculatum G. intraradices, G. lamellosum, G. macrocarpum, G. monosporum, G. mosseae, G. versforme), Gomphidius spp. (e.g., G. glutinosus), Hebeloma spp. (e.g., H. cylindrosporum), Hydnum spp. (e.g., H. repandum), Hymenoscyphus spp. (e.g., H. ericae), Inocybe spp. (e.g., I. bongardii, I. sindonia), Lactarius spp. (e.g., L. hygrophoroides), Lindtneria spp. (e.g., L. brevispora), Melanogaster spp. (e.g., M. ambiguous), Meliniomyces spp. (e.g., M. variabilis), Morchella spp., Mortierella spp. (e.g., M. polycephala), Oidiodendron spp. (e.g., O. maius), Paraglomus spp. (e.g., P. brasilianum), Paxillus spp. (e.g., P. involutus), Penicillium spp. (e.g., P. pinophilum, P. thomili), Peziza spp. (e.g., P. whitei), Pezoloma spp. (e.g., P. ericae); Phlebopus spp. (e.g., P. marginatus), Piloderma spp. (e.g., P. croceum), Pisolithus spp. (e.g., P. tinctorius), Pseudotomentella spp. (e.g., P. tristis), Rhizoctonia spp., Rhizodermea spp. (e.g., R. veluwensis), Rhizophagus spp. (e.g., R. irregularis), Rhizopogon spp. (e.g., R. luteorubescens, R. pseudoroseolus), Rhizoscyphus spp. (e.g., R. ericae), Russula spp. (e.g., R. livescens), Sclerocystis spp. (e.g., S. sinuosum), Scleroderma spp. (e.g., S. cepa, S. verrucosum), Scutellospora spp. (e.g., S. pellucida, S. heterogama), Sebacina spp. (e.g., S. sparassoidea), Setchelliogaster spp. (e.g., S. tenuipes), Suillus spp. (e.g., S. luteus), Thanatephorus spp. (e.g., T. cucumeris), Thelephora spp. (e.g., T. terrestris), Tomentella spp. (e.g., T. badia, T. cinereoumbrina, T. erinalis, T. galzinii), Tomentellopsis spp. (e.g., T. echinospora), Trechispora spp. (e.g., T. hymenocystis, T. stellulata, T. thelephora), Trichophaea spp. (e.g., T. abundans, T. woolhopeia), Tulasnella spp. (e.g., T. calospora), and Tylospora spp. (e.g., T. fibrillose).

In certain preferred embodiments, the subject invention utilizes endomycorrhizal fungi, including fungi from the phylum Glomeromycota and the genera Glomus, Gigaspora, Acaulospora, Sclerocystis, and Entrophospora. Examples of endomycorrhizal fungi include, but not are not limited to, Glomus aggregatum, Glomus brasilianum, Glomus clarum, Glomus deserticola, Glomus etunicatum, Glomus fasciculatum, Glomus intraradices (Rhizophagus irregularis), Glomus lamellosum, Glomus macrocarpum, Gigaspora margarita, Glomus monosporum, Glomus mosseae (Funneliformis mosseae), Glomus versiforme, Scutellospora heterogama, and Sclerocystis spp.

In certain embodiments, the microorganisms are yeasts or fungi. Yeast and fungus species suitable for use according to the current invention, include Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H. uvarum), Hansenula, Issatchenkia, Kluyveromyces (e.g., K. phaffii), Mortierella, Mycorrhiza, Penicillium, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii sequela, S. cerevisiae, S. torula), Starmerella (e.g., S. bombicola), Torulopsis, Trichoderma (e.g., T. reesei, T. harzianum, T. hamatum, T. viride), Ustilago (e.g., U. maydis), Wickerhamomyces (e.g., W. anomalus), Williopsis (e.g., W. mrakii), Zygosaccharomyces (e.g., Z. bailii), and others.

In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. anyloliquefaciens, B. circulans, B. firmus, B. laterosporus, B. licheniformis, B. megaterium, B. mucilaginosus, B. subtilis), Frateuria (e.g., F. aurantia), Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis subsp. aureofaciens (Kluyver), P. putida), Rhizobium spp., Rhodospirillum (e.g., R. rubrum), Sphingomonas (e.g., S. paucimobilis), and/or Thiobacillus thiooxidans (Acidothiobacillus thiooxidans).

In certain embodiments, the microorganisms are capable of fixing and/or solubilizing nitrogen, potassium, phosphorous and/or other micronutrients in soil.

In one embodiment, the microorganism is a nitrogen-fixing microorganism, or a diazotroph, selected from species of, for example, Azospirillum, Azotobacter, Chlorobiaceae, Cyanothece, Frankia, Klebsiella, rhizobia, Trichodesmium, and some Archaea. In a specific embodiment, the nitrogen-fixing bacterium is Azotobacter vinelandii.

In another embodiment, the microorganism is a potassium-mobilizing microorganism, or KMB, selected from, for example, Bacillus mucilaginosus, Frateuria aurantia or Glomus mosseae. In a specific embodiment, the potassium-mobilizing microorganism is Frateuria aurantia.

In certain embodiments, the microorganism is a phosphorous-mobilizing microorganism, for example, Wickerhamomyces anomalus. This microbe produces beneficial organic acids and biosurfactants to help with nutrient and water mobilization, solubilization and absorption in soil. In some embodiments, W. anomalus can solubilize potassium in soil. Additionally, W. anomalus produces the enzyme phytase, which mobilizes phosphates into usable forms of inorganic phosphorus. Furthermore, W. anomalus produces ethyl acetate, which can, in certain embodiments, break down biofilms such as those that are formed by many plant vascular bacterial pathogens. In one embodiment, W. anomalus strain NRRL Y-68030 is utilized.

In one embodiment, the composition can comprise one or more Bacillus spp. microbes, For example, in one embodiment, the composition comprises B. subtilis (e.g., strain NRRL B-68031 “B4”) and B. amyloliquefaciens (e.g., strain NRRL B-67928 “B. amy”).

In one embodiment, the composition can comprise a Trichoderma spp. fungus and/or a Bacillus spp. bacterium. In certain embodiments, the composition comprises Trichoderma harzianum and Bacillus amyloliquefaciens. In a specific embodiment, the Bacillus is B. amy.

In one embodiment, the composition can comprise from 1 to 99% Trichoderma by weight and from 99 to 1% Bacillus by weight. In some embodiments, the cell count ratio of Trichoderma to Bacillus is about 1:9 to about 9:1, about 1:8 to about 8:1, about 1:7 to about 7:1, about 1:6 to about 6:1, about 1:5 to about 5:1 or about 1:4 to about 4:1.

In one embodiment, the composition comprises about 1×10⁶ to 1×10¹², 1×10⁷ to 1×10¹¹, 1×10⁸ to 1×10¹⁰, or 1×10⁹ CFU/ml of Trichoderma. In one specific embodiment, the composition comprises about 1×10⁶ to 1×10¹², 1×10⁷ to 1×10¹¹, 1×10⁸ to 1×10¹⁰, or 1×10⁹ CFU/ml of Bacillus.

Other preferred exemplary microbes can include, for example, Pseudomonas chlororaphis, Starmerella bombicola, Saccharomyces boulardii, Debaryomyces hansenii, Pichia occidentalis, Pichia kudriavzevii, and/or Meyerozyma guilliermondii.

The species and ratio of microorganisms and other ingredients in the composition can be customized according to, for example, the plant being treated, the soil type where the plant is growing, the health of the plant at the time of treatment, the species of pest or pathogen affecting the plant, as well as other factors.

Advantageously, in some embodiments, the combination of microbes works synergistically with one another to promote plant health, growth and/or yields. In an exemplary embodiment, Trichoderma harzianum and B. amy work in synergy with one another as one composition, to promote plant health. Trichoderma harzianum is a beneficial fungus that attaches to, and elongates roots, which aids in the increase of nutrient uptake. B. amy is a beneficial rhizobacterium that produces organic acids that help to solubilize and move nutrients, such as NPK, in the soil, ultimately into the rootzone where the plant roots can absorb them. Both of these microbes also produce biosurfactants, which improve water use efficiency and penetration and uptake of water and nutrients through the roots.

In preferred embodiments, the composition of the subject invention is not a pesticide per se. Rather, in some embodiments, the microorganisms of the subject composition have the ability to outcompete potentially pathogenic bacterial and fungal strains in the soil. The combined effect helps to strengthen the plant overall, which allows it to handle stressors more effectively. In other embodiments, a pathogen remains in a plant, but the deleterious symptoms are reduced and/or eliminated after treatment with the composition of the subject invention.

The microbes and microbe-based compositions of the subject invention have a number of beneficial properties that are useful for promoting plant health, growth, and/or yields. For example, the compositions can comprise products resulting from the growth of the microorganisms, such as biosurfactants, proteins and/or enzymes, either in purified or crude form.

In addition to protecting plants from pathogens and pests, root colonization by these species can, in preferred embodiments, enhance root growth and development, crop productivity, resistance to abiotic stresses, and bioavailability of nutrients.

In one embodiment, the composition is preferably formulated for application to soil, seeds, whole plants, or plant parts (including, but not limited to, roots, tubers, stems, stalks, buds, flowers and leaves). In certain embodiments, the composition is formulated as, for example, liquid, dust, granules, microgranules, pellets, wettable powder, flowable powder, emulsions, microcapsules, oils, or aerosols.

To improve or stabilize the effects of the composition, it can be blended with suitable adjuvants and then used as such or after dilution, if appropriate. In preferred embodiments, the composition is formulated as a liquid, a concentrated liquid, or as dry powder or granules that can be mixed with water and other components to form a liquid product.

In one embodiment, the composition can comprise glucose (e.g., in the form of molasses), glycerol and/or glycerin, as, or in addition to, an osmoticum substance, to promote osmotic pressure during storage and transport of the dry product.

The compositions can be used either alone or in combination with other compounds and/or methods for efficiently enhancing plant health, growth and/or yields, and/or for supplementing the growth of the first and second microbes. For example, in one embodiment, the composition can include and/or can be applied concurrently with nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. The exact materials and the quantities thereof can be determined by a grower or an agricultural scientist having the benefit of the subject disclosure.

The compositions can also be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments. Preferably, however, the composition does not comprise and/or is not used with benomyl, dodecyl dimethyl ammonium chloride, hydrogen dioxide/peroxyacetic acid, imazilil, propiconazole, tebuconazole, or triflumizole.

If the composition is mixed with compatible chemical additives, the chemicals are preferably diluted with water prior to addition of the subject composition.

Further components can be added to the composition, for example, buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, stabilizers and ultra-violet light resistant agents.

The pH of the microbe-based composition should be suitable for the microorganism of interest. In a preferred embodiment, the pH of the composition is about 3.5 to 7.5, about 4.0 to 6.5, or about 5.0.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The microbe-based compositions may be used without further stabilization, preservation, and storage, however. Advantageously, direct usage of these microbe-based compositions preserves a high viability of the microorganisms, reduces the possibility of contamination from foreign agents and undesirable microorganisms, and maintains the activity of the by-products of microbial growth.

In other embodiments, the composition (microbes, growth medium, or microbes and medium) can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 pint to 1,000 gallons or more. In certain embodiments the containers are 1 gallon, 2 gallons, 5 gallons, 25 gallons, or larger.

### Microbial Deposits

In some embodiments, the microorganisms utilized according to the subject invention are specific deposited strains.

In one embodiment, B. amyloliquefaciens strain NRRL B-67928 “B. amy” is utilized. A culture of the B. amy microbe has been deposited with the Agricultural Research Service Northern Regional Research Laboratory (NRRL), 1400 Independence Ave., S.W., Washington, D.C., 20250, USA. The deposit assigned accession number NRRL B-67928 by the depository was deposited on Feb. 26, 2020.

In one embodiment, B. subtilis strain NRRL B-68031 “B4” is utilized. A culture of the B4 microbe has been deposited with the Agricultural Research Service Northern Regional Research Laboratory (NRRL), 1400 Independence Ave., S.W., Washington, D.C., 20250, USA. The deposit assigned accession number NRRL B-68031 by the depository was deposited on May 6, 2021.

In one embodiment, Wickerhamomyces anomalus strain NRRL Y-68030 is utilized. A culture of the W. anomalus strain NRRL Y-68030 microbe has been deposited with the Agricultural Research Service Northern Regional Research Laboratory (NRRL), 1400 Independence Ave., S.W., Washington, D.C., 20250, USA. The deposit assigned accession number NRRL Y-68030 by the depository was deposited on May 6, 2021.

The subject cultures have been deposited under conditions that assure that access to the cultures will be available during the pendency of this patent application to one determined by the Commissioner of Patents and Trademarks to be entitled thereto under 37 CFR 1.14 and 35 U.S.C 122. The deposits are available as required by foreign patent laws in countries wherein counterparts of the subject application, or its progeny, are filed. However, it should be understood that the availability of a deposits does not constitute a license to practice the subject invention in derogation of patent rights granted by governmental action.

Further, the subject culture deposit(s) will be stored and made available to the public in accord with the provisions of the Budapest Treaty for the Deposit of Microorganisms, i.e., they will be stored with all the care necessary to keep them viable and uncontaminated for a period of at least five years after the most recent request for the furnishing of a sample of the deposit(s), and in any case, for a period of at least 30 (thirty) years after the date of deposit or for the enforceable life of any patent which may issue disclosing the culture(s). The depositor acknowledges the duty to replace the deposit(s) should the depository be unable to furnish a sample when requested, due to the condition of the deposit(s). All restrictions on the availability to the public of the subject culture deposit(s) will be irrevocably removed upon the granting of a patent disclosing it.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Preparation of Microbe-Based Products

In some embodiments, the plant-health promoting compositions are “microbe-based products,” which are products that are to be applied in practice to achieve a desired result. The microbe-based product can be simply a microbe-based composition harvested from the microbe cultivation process, or individual components thereof, such as supernatant. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers, and/or agents that facilitate tracking of the microbes and/or the composition in the environment to which it is applied.

The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

In one embodiment, the different strains are not mixed together, but are applied to a plant and/or its environment as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

The pH of the microbe-based composition should be suitable for the microorganism(s) of interest. In a preferred embodiment, the pH of the composition is about 3.5 to 7.0, about 4.0 to 6.5, or about 5.0.

In one embodiment, additional components such as an aqueous preparation of a salt, such as sodium bicarbonate or carbonate, sodium sulfate, sodium phosphate, sodium biphosphate, can be included in the formulation.

In certain embodiments, an adherent substance can be added to the composition to prolong the adherence of the product to plant parts. Polymers, such as charged polymers, or polysaccharide-based substances can be used, for example, xanthan gum, guar gum, levan, xylinan, gellan gum, curdlan, pullulan, dextran and others.

In preferred embodiments, commercial grade xanthan gum is used as the adherent. The concentration of the gum should be selected based on the content of the gum in the commercial product. If the xanthan gum is highly pure, then 0.001% (w/v—xanthan gum/solution) is sufficient.

In one embodiment, glucose, glycerol and/or glycerin can be added to the microbe-based product to serve as, for example, an osmoticum during storage and transport. In one embodiment, molasses can be included.

In one embodiment, prebiotics can be added to and/or applied concurrently with the microbe-based product to enhance microbial growth. Suitable prebiotics, include, for example, kelp extract, fulvic acid, chitin, humate and/or humic acid. In a specific embodiment, the amount of prebiotics applied is about 0.1 L/acre to about 0.5 L/acre, or about 0.2 L/acre to about 0.4 L/acre.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

Advantageously, the compositions can be tailored for use at a specified location. In one embodiment, the microbe growth facility is located on, or near, a site where the microbe-based products will be used (e.g., a citrus grove).

Advantageously, these microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products to improve agricultural production.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### Methods of Promoting Plant Health

In preferred embodiments, methods are provided for promoting the health of a plant that is infected by, or is at risk for being infected by, a pest or pathogen.

In certain embodiments, the methods can comprise contacting a health-promoting composition of the subject invention with the plant and/or its surrounding environment. In certain other embodiments, the methods can comprise contacting a microbial growth by-product, such as a biosurfactant, with the plant and/or its surrounding environment. In further embodiments, the methods can comprise applying both the microbe-based health-promoting composition and a biosurfactant.

In certain embodiments, the pest or pathogen causes a disease and/or symptom affecting the plant vascular tissue, such as, e.g., Xylella fastidiosa (e.g., X. fastidiosa subspp. fastidiosa, multiplex, pauca, sandyi, tashke, and morus), Candidatus liberibacter spp. (e.g., C. L. africanus, C. L. americanus, C. L., asiaticus, C. L. crescens, C. L. europaeus, C. L. psyllaurous, C. L. solanacearum, C. L. brunswickensis), Xanthomonas spp. (e.g., X. oryzae, X. campestris), Ralstonia solanacearum, Erwinia spp. (E. amylovora, E. tracheiphila), Curtobacterium flaccumfaciens, Pantoea stewartii, Verticillium spp. (e.g., V. dahliae, V. albo-atrum, V. longisporum, V. nubilum, V. theobromae and V. tricorpus), Fusarium spp. (e.g., F. avenaceum, F. bubigeum, F. culmorum, F. graminearum, F. langsethiae, F. oxysporum, F. proliferatum, F. sporotrichioides, F. poae, F. reseum, F. solani, F. tricinctum, F. verticilloides, F. virguliforme, F. xylariodides), Clavibacter michiganensis, Ceratocystis spp., Pseudomonas syringae, Ca. Phytoplasma spp. (e.g., Ca. P. palmae, Ca. P. palmicola, Ca. P. costaricanum, Ca. P. fragariae), Ophiostoma ulmi, Bretziella fagacearum, and Acromonium diospyri.

The method can be used in any plant species that is susceptible to infection by a vascular infection. In an exemplary embodiment, the plant is a member of the Olea genus, which includes olives (O. europaea).

In a specific embodiment, the pest or pathogen is a biofilm-forming bacterium, such as Xylella fastidiosa, which forms biofilms in the vascular tissue (e.g., xylem and/or phloem tissue), thereby choking off the supply of water and/or nutrients throughout the plant.

In some embodiments, the method promotes plant health by directly controlling a pest or pathogen, or a vector that carries a pest or pathogen, and/or by treating a symptom caused by infection with a pest or pathogen.

In some embodiments, the method promotes plant health by promoting the plant's immune response to a pest or pathogen, thereby enhancing the plant's ability to survive and/or resist an infection by the pest or pathogen.

In one embodiment, improvement in the plant's immune response comprises enhancing the ability of the plant's pattern recognition receptors (PRR) to recognize an invader-associated molecular pattern (IAMP) and/or a pathogenic effector molecule, and subsequently react to said recognition by transmitting a signal inside the plant cells that induces a defense mechanism. In certain embodiments, the IAMP is a pathogen-associated molecular pattern (PAMP).

In some embodiments, the immune supplement serves as a priming agent, wherein priming comprises pre-exposing the plant to an IAMP and/or a pathogenic effector molecule, thus triggering a defense mechanism in the plant and inducing the plant into a state of defense and/or resistance prior to the plant being infected by a pathogen.

In some embodiments, improvement in the plant's immune response comprises enhancing the reaction of the plant's PRR upon recognition of an IAMP and/or pathogenic effector molecule. For example, the methods can enhance induction of a defense mechanism in the plant by, for example, increasing the speed at which a signal is produced and/or transmitted by the PRR, and/or increasing the quantity at which a defense mechanism (e.g., a defensive molecule) is deployed by the plant. Xylella fastidiosa, for example, contains a long chain O-antigen that allows it to delay plant recognition, thus allowing it to bypass the innate immunity and become established in the plant host.

In certain embodiments, improvement in the plant's immune response comprises reducing a deleterious reaction of the plant's PRR upon recognition of an IAMP and/or pathogenic effector molecule. For example, the methods can reduce induction of a defense mechanism that is causing harm to the plant because, for example, it is irreversible and/or it is being over-induced in the plant. HLB, for example, is thought to induce a response that is analogous to an auto-immune response in animals, where the plant, for example, over-produces polysaccharides that can plug the phloem and/or alters the structure of phloem cell walls to prevent the further spread of pathogenic cells. By reducing the nutrient and water stress on the plant's roots and vascular system, the subject methods can, in some embodiments, reduce the “auto-immune” response that is induced by the presence of the pest or pathogen, thereby improving the symptoms it causes.

Plant defense mechanisms modulated according to the subject methods, include, but are not limited to, release of an anti-microbial compound in the plant to control pathogenic invaders; production of a reactive oxygen species (ROS); induction of a hypersensitive response (HR), or programmed cell death, at the site of infection; alterations in gene expression and/or hormone expression to up- or down-regulate certain defensive and/or protective mechanisms; up-regulation of carbohydrate synthesis; alteration of gene expression encoding proteins involved in cell wall synthesis, assembly and modification, including phloem proteins; up-regulation of callose deposition in parts of the plant; and/or others.

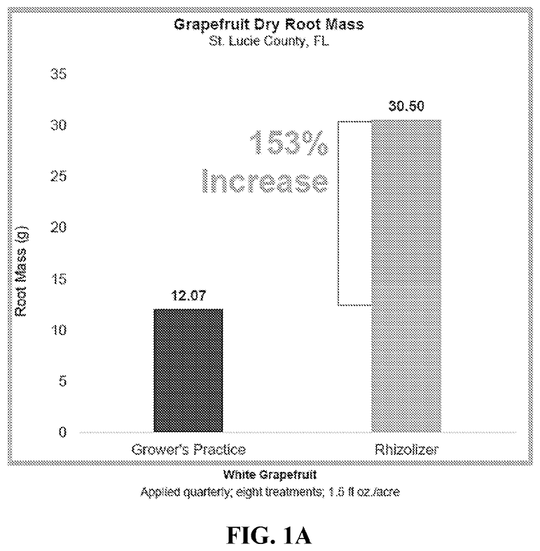

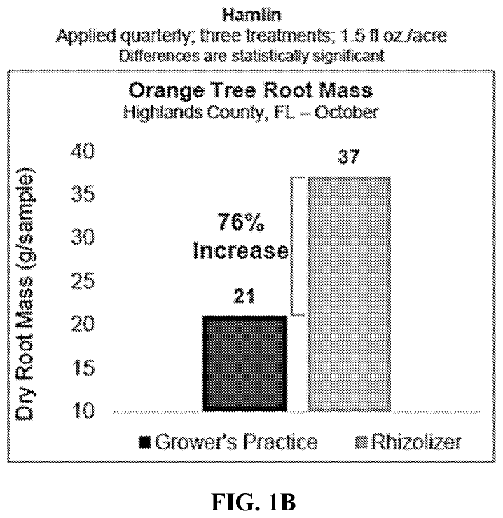

In some embodiments, the method promotes plant health by expanding the plant's root system to decrease pressure on, and increase the functionality of, roots that are compromised due to disease. FIGS. 1A-1B.

In some embodiments, the method promotes plant health by improving water and nutrient transport through the xylem and phloem, even in diseased plants. For example, the composition can comprise biosurfactants, either produced by the microorganisms of the composition or applied as an additional component. Due to their amphiphilic nature, the biosurfactants can reduce the surface tension of water around the root system, as well as within the vascular system, to help with nutrient and water transport through the xylem and phloem.

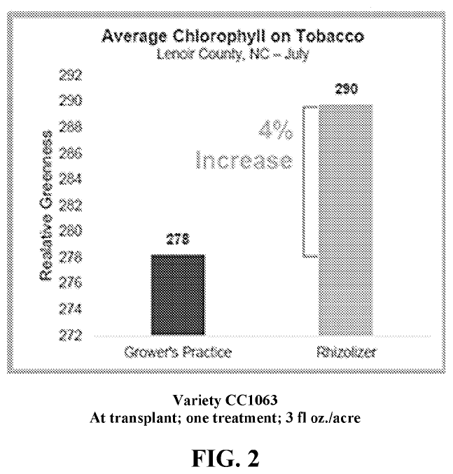

In some embodiments, the method promotes plant health by improving nutrient availability to the root system. For example, the composition can comprise organic acids either produced by the microorganisms of the composition or applied as an additional component. The organic acids improve nutrient availability to the extended root system by solubilizing the nutrient compounds into usable forms. In some embodiments, plants treated with a composition comprising according to the subject invention can have higher chlorophyll and tissue nitrogen levels, indicating nutrient use efficiency. FIG. 2.

### Application of the Microbe-Based Health-Promoting Composition

As used herein, “applying” a composition or product, or “treating” an environment refers to contacting a composition or product with a target or site such that the composition or product can have an effect on that target or site. The effect can be due to, for example, microbial growth and/or the action of a metabolite, enzyme, biosurfactant or other growth by-product.

Application can include contacting a composition directly with a plant, plant part, and/or the plant's surrounding environment (e.g., the soil). The composition can be applied as a seed treatment or to the soil surface, or to the surface of a plant or plant part (e.g., to the surface of the roots, tubers, stems, flowers, leaves, fruit, or flowers). It can be sprayed as a liquid or a dry powder, dust, granules, microgranules, pellets, wettable powder, flowable powder, emulsions, microcapsules, To improve or stabilize the effects of the composition, it can be blended with suitable adjuvants and then used as such or after dilution if necessary.

In preferred embodiments, the composition is formulated as a dry powder, which can be mixed with water and other components to form a liquid product. In one embodiment, the composition can comprise glucose, in addition to an osmoticum substance, to ensure appropriate osmotic pressure during storage and transport of the dry product. In one embodiment, the osmoticum substance can be glycerin.

In certain embodiments, the composition is contacted with a plant part. In a specific embodiment, the composition is contacted with one or more roots of the plant. The composition can be applied directly to the roots, e.g., by spraying or pouring onto the roots, and/or indirectly, e.g., by administering the composition to the soil in which the plant roots are growing (i.e., the rhizosphere). The composition can be applied to the seeds of the plant prior to or at the time of planting, or to any other part of the plant and/or its surrounding environment.

In one embodiment, the composition is applied to a plant that has been diagnosed with a pathogen such as, for example, Xanthomonadaceae or Candidatus liberibacter, or any of the other pathogens described herein. Alternatively, such pathogen may have been detected in the vicinity of the plant to be treated. The vicinity may be, for example, 10, 20, 50, 100, 1000 or 5000 feet of the plant, or within 2 miles.

In one embodiment, wherein the method is used in a large scale setting, the method can comprise administering the composition into a tank connected to an irrigation system used for supplying water, fertilizers, or other liquid compositions to a crop, orchard or field. Thus, the plant and/or soil surrounding the plant can be treated with the composition via, for example, soil injection, soil drenching, or using a center pivot irrigation system, or with a spray over the seed furrow, or with sprinklers or drip irrigators. Advantageously, the method is suitable for treating hundreds of acres of a plantation, crop, orchard or field at one time.

In one embodiment, wherein the method is used in a smaller scale setting, such as in a home garden or greenhouse, the method can comprise pouring the composition into the tank of a handheld lawn and garden sprayer and spraying a plant and/or its surrounding environment with the mixture.

Plants and/or their environments can be treated at any point during the process of cultivating the plant. For example, the composition can be applied prior to, concurrently with, or after the time when seeds are planted. It can also be applied at any point thereafter during the development and growth of the plant, including when the plant is flowering, fruiting, and during and/or after abscission of leaves.

In certain embodiments, the compositions provided herein are applied to the soil surface without mechanical incorporation. The beneficial effect of the soil application can be activated by rainfall, sprinkler, flood, or drip irrigation, and subsequently delivered to, for example, the roots of plants to influence the root microbiome or facilitate uptake of the microbial product into the vascular system of the crop or plant to which the microbial product is applied. In an exemplary embodiment, the compositions provided herein can be efficiently applied via a center pivot irrigation system or with a spray over the seed furrow.

In certain embodiments, the methods can comprise applying nutrients to enhance the growth of the one or more microorganisms and/or production of health-promoting growth by-products. Such nutrients can include, for example, sources of carbon, nitrogen, potassium, phosphorus, magnesium, proteins, micronutrients, vitamins and/or amino acids.

### Biosurfactant Treatment

In certain embodiments, the method can comprise applying a biosurfactant composition to the plant and/or its surrounding environment. The biosurfactant can be applied as a supplement to the health-promoting composition, and/or it can be applied as a stand-alone treatment.

Biosurfactants according to the subject invention include, for example, glycolipids, cellobiose lipids, lipopeptides, flavolipids, phospholipids, and high-molecular-weight polymers such as lipoproteins, lipopolysaccharide-protein complexes, and/or polysaccharide-protein-fatty acid complexes.

In one embodiment, the biosurfactants comprise glycolipids such as, for example, rhamnolipids (RLP), sophorolipids (SLP), trehalose lipids or mannosylerythritol lipids (MEL). In one embodiment, the biosurfactants comprise lipopeptides, such as, e.g., surfactin, iturin, fengycin, athrofactin, viscosin and/or lichenysin.

Biosurfactants are a structurally diverse group of surface-active substances produced by microorganisms. Biosurfactants are amphiphiles consisting of two parts: a polar (hydrophilic) moiety and non-polar (hydrophobic) group. The hydrocarbon chain of a fatty acid acts as the common lipophilic moiety of a biosurfactant molecule, whereas the hydrophilic part is formed by ester or alcohol groups of neutral lipids, by the carboxylate group of fatty acids or amino acids (or peptides), organic acids in the case of flavolipids, or, in the case of glycolipids, by a carbohydrate.

Due to their amphiphilic structure, biosurfactants increase the surface area of hydrophobic water-insoluble substances and increase the water bioavailability of such substances. Additionally, biosurfactants accumulate at interfaces, thus reducing interfacial tension and leading to the formation of aggregated micellar structures in solution. The ability of biosurfactants to form pores and destabilize biological membranes permits their use as, e.g., antibacterial and antifungal agents.

Furthermore, biosurfactants can inhibit adhesion of undesirable microorganisms to a variety of surfaces, prevent the formation of biofilms, and can have powerful emulsifying and demulsifying properties. Even further, biosurfactants can also be used to improve wettability and to achieve even solubilization and/or distribution of fertilizers, nutrients, and water in the soil.

Advantageously, biosurfactants are biodegradable and can be efficiently produced, according to the subject invention, using selected organisms on renewable substrates. Most biosurfactant-producing organisms produce biosurfactants in response to the presence of a hydrocarbon source (e.g. oils, sugar, glycerol, etc.) in the growing media. Other media components such as concentration of iron can also affect biosurfactant production significantly.

In certain embodiments, the biosurfactant composition comprises more than one type of biosurfactant. The biosurfactants can be purified and/or in crude form.

In some embodiments, the concentration of the biosurfactant in the biosurfactant composition is about 0.001 to about 5.0%, or about 0.005% to about 1.0%, or about 0.01% to about 0.1%, or about 0.05% by weight.

In a specific embodiment, the biosurfactant composition comprises a sophorolipid at a concentration of approximately 5 to 50 ppm, 10 to 40 ppm, or more preferably about 20 to 30 ppm. The sophorolipid can be a lactonic or an acidic form sophorolipid, or a combination of the two forms. In some embodiments, sophorolipids are particularly advantageous due to their nano-scale micelle size (e.g., less than 20 nm). This can allow for enhanced penetration of spaces such as cell membranes and cell junctions, thereby enhancing the transport of nutrients and water through these spaces, and/or the disruption of biofilm matrices.

Advantageously, biosurfactants can provide benefits include, for example, enhancing the water solubility and/or absorption of nutrients from soil. Furthermore, due to the amphiphilic nature of biosurfactant molecules, they are capable of traveling through the plant's vascular system, where they can promote immune health by, for example, dissolving the polysaccharide matrix that helps form xylem- and phloem-clogging biofilms and/or directly controlling the pathogens that form them. Even further, due to their ability to reduce the surface tension within the vascular system, the biosurfactants can improve the overall circulation of water and nutrients throughout the plant.

In one embodiment, the method comprises applying the biosurfactant treatment composition to a plant and/or its surrounding environment either after, or simultaneously with, application of the health-promoting composition.

The biosurfactant composition can be applied continuously, as a single treatment, or as a plurality of serial treatments with limited time between each.

In some embodiments, the biosurfactant composition is applied to the soil in which the plant is growing, where it can be absorbed by plant roots and transported through the vascular system of the plant.

In one embodiment, the biosurfactant treatment is applied in such a way that it does not contact the microorganisms of the health-promoting composition. For example, in one embodiment, the biosurfactant composition is applied directly to a part of the plant other than the roots. The biosurfactant composition can be applied directly to the inside of a plant, for example, into the vascular system (xylem and phloem) of the plant. Direct application according to this embodiment can comprise, for example, using a syringe to inject the biosurfactant treatment into, for example, the plant's trunk, branches, stems and/or foliage. For trunks and/or stems of trees and larger plants, it may be necessary to drill a small hole into the trunk or stem to insert the syringe. Direct application can also comprise, for example, spraying the composition onto the trunk, branches, stems, foliage, flowers and/or fruits of the plant.

Advantageously, this embodiment of the method allows for survival of the microorganisms present in the health-promoting composition, as the biosurfactant treatment is not applied to the soil where those microorganisms are present. Furthermore, injecting the treatment straight into a plant's circulatory system allows the compositions to dissipate rapidly throughout the plant while minimizing the amount of composition needed.

In some embodiments, the biosurfactant composition is applied to the plant and/or its environment without applying the health-promoting composition to the soil. In some embodiments, the health-promoting composition is applied to the soil without application of a biosurfactant composition.

### Other Considerations

Advantageously, the subject method can even be used to promote the health, growth and/or yields of plants having compromised immune health due to an infection by pests or pathogens, particularly those that affect the plant vascular system. Furthermore, the subject method can be used to reduce the amount of plant and/or crop loss due to plant damage and/or death caused by such infections.

In certain embodiments, the present invention can be used to promote growth and yields of plants, despite being infected with a pest or pathogen.

In certain embodiments, the methods and compositions according to the subject invention reduce damage to a plant caused by a vascular pest or pathogen by about 5%, 10%, 20%, 30%, 40%, 50%, 60% 70%, 80%, or 90% or more, compared to plants growing in an untreated environment.

In certain embodiments, the methods and compositions according to the subject invention lead to an increase in crop yield by about 5%, 10%, 20%, 30%, 40%, 50%, 60% 70%, 80%, or 90% or more, compared to untreated crops.

In one embodiment, the methods of the subject invention lead to a reduction in the amount of a vascular pest or pathogen in or on a plant or in a plant's surrounding environment by about 5%, 10%, 20%, 30%, 40%, 50%, 60% 70%, 80%, or 90% or more, compared to a plant growing in an untreated environment.

In one embodiment, the methods of the subject invention lead to an increase in the above-ground mass, root mass, trunk caliper, height, canopy density, fruit size, fruit mass, fruit number, chlorophyll rating, nitrogen content, leaf size, and/or brix measurement of a plant by about 5%, 10%, 20%, 30%, 40%, 50%, 60% 70%, 80%, or 90% or more, compared to a plant growing in an untreated environment.

The subject invention can also be used as a “niche-clearing” agent. In one embodiment, the health-promoting composition, and/or the biosurfactant composition, can be used to disrupt the existing balance of microorganisms present in the soil in which a plant is growing.

In certain embodiments, the soil microbiome in which a plant is growing comprises deleterious microbes, such as, for example, Xylella spp. bacteria or Fusarium spp. fungi. By clearing out or reducing the soil microbiome population, the subject methods provide for re-colonization of the rhizosphere with one or more beneficial microorganisms, which, in certain embodiments, can ward off and/or out-compete any deleterious species that may try to colonize or re-colonize.

Thus, in some embodiments, the method comprises clearing the soil microbiome using a composition of the subject invention, followed by applying an enhancing agent for promoting beneficial microbe growth and/or directly inoculating the rhizosphere with one or more beneficial microorganisms.

In one embodiment, the beneficial microorganisms are, for example, the microorganisms of the health-promoting compositions.

The subject invention can also be used to improve a variety of qualities in any type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof.

In one embodiment, the method can be used for improving the drainage and/or dispersal of water in waterlogged soils. In one embodiment, the method can be used for improving water retention in dry soil. In one embodiment, the method can be used for improving nutrient retention in porous and/or depleted soils.

In one embodiment, the method controls pathogenic microorganisms themselves. In one embodiment, the method works by enhancing the immune health of plants to increase the ability to fight off infections.

In yet another embodiment, the method controls any pests that might act as vectors or carriers for pathogenic microorganisms, for example, insects, such as flies, aphids, ants, beetles, whiteflies, etc., that land on the plant and come in contact with the pathogen. Thus, the subject methods can prevent the spread of plant pathogenic microorganisms by controlling, i.e., killing, these carrier pests.

The method can be used either alone or in combination with application of other compounds for efficient enhancement of plant immunity, health, growth and/or yields, as well as other compounds for efficient treatment and prevention of plant pathogenic pests. For example, commercial and/or natural fertilizers, antibiotics, pesticides, herbicides and/or soil amendments can be applied alongside the compositions of the subject invention. In one embodiment, the method comprises applying fatty acid compositions alongside the subject compositions, including, for example, unsubstituted or substituted, saturated or unsaturated fatty acids, and/or salts or derivatives thereof.

Preferably, the composition does not comprise and/or is not applied simultaneously with, or within 7 to 10 days before or after, application of the following compounds: benomyl, dodecyl dimethyl ammonium chloride, hydrogen dioxide/peroxyacetic acid, imazilil, propiconazole, tebuconazole, or triflumizole.

In certain embodiments, the compositions and methods can be used to enhance the effectiveness of other compounds, for example, by enhancing the penetration of a pesticidal compound into a plant or pest, or enhancing the bioavailability of a nutrient to plant roots. The microbe-based products can also be used to supplement other treatments, for example, antibiotic treatments. Advantageously, the subject invention helps reduce the amount of antibiotics that must be administered to a crop or plant in order to be effective at treating and/or preventing bacterial infection.

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

As used herein, “crop plants” refer to any species of plant or alga, grown for profit and/or for sustenance for humans, animals or aquatic organisms, or used by humans (e.g., textile, cosmetics, and/or drug production), or viewed by humans for pleasure (e.g., flowers or shrubs in landscaping or gardens) or any plant or alga, or a part thereof, used in industry, commerce or education. Crop plants can be plants that can be obtained by traditional breeding and optimization methods or by biotechnological and recombinant methods, or combinations of these methods, including the transgenic plants and the plant varieties.

In exemplary embodiments, the plants are selected from olive, grapevines, citrus, peach, coffee, almond, strawberry, banana, blueberry, elm, oleander, sycamore, sorghum, tobacco, lucerne, plum, oak, plane, mulberry, and maple.

Types of crop plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Additional examples of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

In certain embodiments, the crop plant is a citrus plant. Examples of citrus plants according to the subject invention include, but are not limited to, orange trees, lemon trees, lime trees and grapefruit trees. Other examples include Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantifolia (Key lime), Citrus x aurantium (Bitter orange), Citrus x latiolia (Persian lime), Citrus x limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu.

In some embodiments, the crop plant is a relative of a citrus plant, such as orange jasmine, limeberry, and trifoliate orange (Citrus trifolata).

Additional examples of target plants include all plants that belong to the superfamily Viridiplantae, in particular monocotyledonous and dicotyledonous plants including fodder or forage legumes, ornamental plants, food crops, trees or shrubs selected from Acer spp. (e.g., A. rubrum), Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp. (e.g., C. illinoinensis), Carthamus tinctorius, Castanea spp., Ceiba pentandra, Cichorium endivia, Cinnamomum spp., Citrofortunella microcarpa, Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Cyperaceae spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus spp. (e.g., F. carica, F. elastic), Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Liquidambar styraciflua, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Mapighia emarginata, Mammea americana, Mangifera indica, Manihot spp., Manilkara zapota, Medicago sativa, Melilotus spp., Mentha spp., Miscanthus sinensis, Momordica spp., Morus spp. (e.g., M. nigra, M alba, M rubra), Musa spp., Nerium oleander, Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp. (e.g., P. americanai), Petroselinum crispum, Phalaris arundinacea, Phaseolus spp., Phleum pratense, Phoenix spp., Phragmites australis, Physalis spp., Pinus spp., Pistacia vera, Pisum spp., Platanus occidentalis, Poa spp., Polygala myrtifolia, Poncirus trifoliate, Populus spp., Prosopis spp., Prunus spp. (e.g., P. angustifolia, P. avium, P. cerasifera, P. domestica, P. dulcis, P. persica, P. salicina), Psidium spp., Punica granatum, Pyrus communis, Quercus spp. (e.g., Q. palustris, Q. rubra), Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum spp. (e.g., S. bicolor, S. halepense), Spartium junceum, Spinacia spp., Syzygium spp., Tagetes spp., Tamarindus indica, Theobroma cacao, Trifolium spp., Tripsacum dactyloides, Triticosecale rimpaui, Triticum spp. (e.g., T aestivum, T. durum, T. turgidum, T. hybernum, T. macha, T. sativum, T. monococcum or T vulgare), Tropaeolum minus, Tropaeolum majus, Ulmus americana, Vaccinium spp. (e.g., V. corymbosum, V virgatum), Vicia spp., Vigna spp., Vinca minor, Viola odorata, Vitis spp. (e.g., V labrusca, V. vinifera), Westringia fruticose, Zizania palustris, Ziziphus spp., amongst others.

Target plants can also include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), rubber (Ficus elastic), oats, barley, vegetables, ornamentals, and conifers.

Target vegetable plants include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamnaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Target turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetun clandesinum); seashore paspalum (Paspalum vaginatum); blue gramma (Bouteloua gracilis); buffalo grass (Buchloe dactyloids); sideoats gramma (Bouteloua curtipendula).

Further plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

In some embodiments, the plant is a plant infected by a pathogenic disease or pest. In specific embodiments, the plant is infected with citrus greening disease and/or citrus canker disease, and/or a pest that carries such diseases.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Solid State Fermentation of Bacillus Microbes

For Bacillus spp. spore production, a wheat bran-based media is used. The media is spread onto stainless steel pans in a layer about 1 to 2 inches think and sterilized.

Following sterilization, the pans are inoculated with seed culture. Optionally, added nutrients can be included to enhance microbial growth, including, for example, salts and/or carbon sources such as molasses, starches, glucose and sucrose. To increase the speed of growth and increase the motility and distribution of the bacteria throughout the culture medium, potato extract or banana peel extract can be added to the culture.

Spores of the Bacillus strain of choice are then sprayed or pipetted onto the surface of the substrate and the trays are incubated between 32-40° C. Ambient air is pumped through the oven to stabilize the temperature. Incubation for 48-72 hours can produce 1×10¹⁰ spores/gram or more of the strain.

### Example 2—Solid State Fermentation of Fungal Spores

For growing Trichoderma spp., 250 g of nixtamilized corn flour is mixed with deionized water and sterilized in a stainless steel pan, sealed with a lid and pan bands. The corn flour medium is aseptically inoculated with Trichoderma seed culture by spraying or pipetting. The pans are then incubated at 30° C. for 10 days. After 10 days, approximately 10⁹ propagules/gram or more of Trichoderma can be harvested. Trichoderma propagules (conidia and/or hyphae) harvested from one batch can treat, for example, 1,000 to 2,000 acres of land.

### Example 3—Preparation of Microbe-Based Product

The microbes, substrate, and any residual nutrients that result from production using the methods described in Examples 1 and 2 can be blended and/or micronized and dried to form granules or a powder substance. Different strains of microbe are produced separately and then mixed together either before or after drying.

A sealable pouch can be used to store and transport a product containing a mixture of 10⁹ cells/g of T. harzianum and 10¹⁰ cells/g of B. amyloliquefaciens. Micronutrients, or other microbes similarly produced, can be added to the product.

To prepare for use, the dry product is dissolved in water. The concentration can reach at least 5×10⁹ to 5×10¹⁰ cells/ml. The product is then diluted with water in a mixing tank to a concentration of 1×10⁶ to 1×10⁷ cells/ml.

One bag can be used to treat approximately 20 acres of crop, or 10 acres of citrus grove.

### Example 4—Starter Materials

Microbial compositions, such as those prepared according to Examples 1-3, can be mixed with and/or applied concurrently with additional “starter” materials to promote initial growth of the microorganisms in the composition. These can include, for example, prebiotics and/or nano-fertilizers (e.g., Aqua-Yield, NanoGro™).

One exemplary formulation of a starter composition comprises:
Soluble potash (K2O) (1.0% to 2.5%, or about 2.0%)
Magnesium (Mg) (0.25% to 0.75%, or about 0.5%)
Sulfur (S) (2.5% to 3.0%, or about 2.7%)
Boron (B) (0.01% to 0.05%, or about 0.02%)
Iron (Fe) (0.25% to 0.75%, or about 0.5%)
Manganese (Mn) (0.25% to 0.75%, or about 0.5%)
Zinc (Zn) (0.25% to 0.75%, or about 0.5%)
Humic acid (8% to 12%, or about 10%)
Kelp extract (5% to 10%, or about 6%)
Water (70% to 85%, or about 77% to 80%).

The microbial inoculant, and/or optional growth-promoting “starter” materials, are mixed with water in an irrigation system tank and applied to soil.

### Example 4—Microbial Strains

The subject invention utilizes beneficial microbial strains. Trichoderma harzianum strains can include, but are not limited to, T-315 (ATCC 20671); T-35 (ATCC 20691); 1295-7 (ATCC 20846); 1295-22 [T-22] (ATCC 20847); 1295-74 (ATCC 20848); 1295-106 (ATCC 20873); T12 (ATCC 56678); WT-6 (ATCC 52443): Rifa T-77 (CMI CC 333646); T-95 (60850); T12m (ATCC 20737); SK-55 (No. 13327; BP 4326 NIBH (Japan)); RR17Bc (ATCC PTA 9708); TSHTH20-1 (ATCC PTA 10317); AB 63-3 (ATCC 18647); OMZ 779 (ATCC 201359); WC 47695 (ATCC 201575); m5 (ATCC 201645); (ATCC 204065); UPM-29 (ATCC 204075); T-39 (EPA 119200); and/or F11Bab (ATCC PTA 9709).

Bacillus amyloliquefaciens strains can include, but are not limited to, NRRL B-67928, FZB24 (EPA 72098-5; BGSC 10A6), TA208, NJN-6, N2-4, N3-8, and those having ATCC accession numbers 23842, 23844, 23843, 23845, 23350 (strain DSM 7), 27505, 31592, 49763, 53495, 700385, BAA-390, PTA-7544, PTA-7545, PTA-7546, PTA-7549, PTA-7791, PTA-5819, PTA-7542, PTA-7790, and/or PTA-7541.

### REFERENCES

Dalio, R. J. D., et al. (2017). “PAMPs, PRRs, effectors and R-genes associated with citrus-pathogen interactions. Annals of Botany 119(5): 749-74. (“Dalio et al. 2017”).
Keener, A. B. “Holding Their Ground.” The Scientist Magazine. Feb. 1, 2016. https://www.the-scientist.com/features/holding-their-ground-34128. (“Keener 2016”).
Kehr, J. (2006). “Phloem sap proteins: their identities and potential roles in the interaction between plants and phloem-feeding insects.” J. Exper. Botany 57(4):767-74. (“Kehr 2006”).
Tugizimana, F., et al. (2018). “Metabolomics in Plant Priming Research: The Way Forward?” Int. J. Mol. Sci. 19, 1759, doi:10.3390/ijms19061759. (“Tugizimana et al. 2018”).

1. A method of promoting plant health in a plant with an infection by a vascular pest or pathogen, the method comprising applying a plant health-promoting composition comprising one or more microorganisms and/or growth by-products thereof to the plant and/or its surrounding environment,
wherein the microorganisms are selected from Trichoderma harzianum, Bacillus amyloliquefaciens, Bacillus subtilis, Bacillus licheniformis, Pseudomonas chlororaphis, Starmerella bombicola, Saccharomyces boulardii, Debaryomyces hansenii, Meyerozyma guilliermondii, Pichia occidentalis, Pichia kudriavzevii, Wickerhamomyces anomalus, and Debaryomyces hansenii.

2. (canceled)

3. The method of claim 1, wherein the method comprises applying one or more microorganisms selected from Trichoderma harzianum, Bacillus amyloliquefaciens NRRL B-67928, Bacillus subtilis NRRL B-68031, and Wickerhamomyces anomalus NRRL Y-68030.

4-12. (canceled)

13. The method of claim 1, further comprising applying a biosurfactant composition to the plant and/or its environment, wherein the biosurfactant composition comprises one or more glycolipids and/or lipopeptides.

14. The method of claim 13, wherein the biosurfactant composition is injected into the plant's vascular system.

15. (canceled)

16. The method of claim 1, wherein the plant is selected from olive, peach, avocado, strawberry, rubber, tobacco, grape, elm, coffee, cacao, banana, alfalfa, palm and tree nuts.

17. The method of claim 1, wherein the vascular pest or pathogen is selected from: Xylella fastidiosa, Candidatus liberibacter spp., Xanthomonas spp., Ralstonia solanacearum, Erwinia spp., Curtobacterium flaccumfaciens, Pantoea stewartii, Verticillium spp., Fusarium spp., Clavibacter michiganensis, Ceratocystis spp., Pseudomonas syringae, Ca. Phytoplasma spp. Ophiostoma ulmi, Bretziella fagacearum, and Acromonium diospyri.

18. (canceled)

19. The method of claim 1, wherein the pest or pathogen is a biofilm-forming microorganism, and wherein the pest or pathogen is controlled via disruption of the biofilm.

20. The method of claim 1, wherein the plant's health is promoted by improving an immune response by the plant.

21. The method of claim 20, wherein improvement in the plant's immune response comprises enhancing the ability of the plant's pattern recognition receptors (PRR) to recognize invader-associated molecular patterns (IAMP) and/or pathogenic effector molecules.

22. (canceled)

23. The method of claim 21, wherein upon recognition of the IAMP and/or pathogenic effector molecule by the PRR, the PRR reacts by transmitting a signal inside the plant cells, said signal inducing a defense mechanism in the plant, and wherein the reaction of the PRR is enhanced.

24. The method of claim 23, wherein induction of a defense mechanism is enhanced by increasing the speed at which a signal is produced and/or transmitted by the PRR to induce the defense mechanism, increasing the rate of signal reception, and/or increasing the quantity at which a defensive molecule is produced and/or deployed by the plant.

25. The method of claim 24, wherein the defense mechanism is a release of an anti-microbial compound, production of a reactive oxygen species (ROS), hypersensitive response, or altered gene and/or hormone expression.

26. The method of claim 20, wherein improvement in the plant's immune response comprises priming the plant, or pre-exposing the plant to an IAMP and/or a pathogenic effector molecule, thus triggering a defense mechanism in the plant and inducing the plant into a state of defense and/or resistance prior to infection by a pathogen.

27. The method of claim 20, wherein the improvement in the plant's immune response comprises reducing induction of a defense mechanism by the plant's PRR, wherein the defense mechanism is causing harm to the plant because it is irreversible and/or it is being over-induced.

28. The method of claim 27, wherein the defense mechanism is hypersensitive response or is up-regulation of carbohydrate synthesis, or wherein the defense mechanism is alteration of gene expression encoding proteins involved in cell wall synthesis, assembly and modification.

29-30. (canceled)

31. A method of improving plant health, the method comprising contacting a biosurfactant composition with the vascular system of the plant, herein the biosurfactant is injected directly into the plant's vascular system.

32-33. (canceled)

34. The method of claim 31, wherein the biosurfactant is a sophorolipid.

35. The method of claim 31, wherein the plant's health is improved via disruption of pathogenic biofilms that have infected the plant's vascular system.

36. The method of claim 31, wherein the plant's health is improved via enhanced water and nutrient circulation throughout the plant's vascular system.
